(19) United States
(12) Patent Application Publication
(10) Pub. No.: US 2012/0020474 A1
(43) Pub. Date: Jan. 26, 2012

(54) RECORDING DEVICE, CONTROLLER, CONTROL METHOD OF RECORDING DEVICE

(75) Inventors: Yoshiyuki Kudoh, Kawasaki-shi (JP); Teruji Yamakawa, Tokyo (JP)

(73) Assignee: KABUSHIKI KAISHA TOSHIBA, Tokyo (JP)

(21) Appl. No.: 13/107,846

(22) Filed: May 13, 2011

(30) Foreign Application Priority Data
Jul. 20, 2010 (JP) 2010-163015

(51) Int. Cl. H04L 9/28

(52) U.S. Cl. 380/28

(57) ABSTRACT

According to some embodiments, there is provided a recording device. The recording device includes: a recording medium having a plurality of sectors; a first writing module configured to write, on a first sector of the plurality of sectors, a first data encrypted using a first encryption key and first encryption key information indicative of the first encryption key; and a re-encrypting module configured to: read the first data from the recording medium; decrypt the first data using the first encryption key to generate decrypted first data; encrypt the decrypted first data using a second encryption key to generate encrypted second data; and write, on the first sector, the encrypted second data and second encryption key information indicative of the second encryption key.

This application claims priority from Japanese Patent Application No. 2010-163015, filed on Jul. 20, 2010, the entire contents of which are hereby incorporated by reference.

### BACKGROUND

1. Field

Embodiments described herein generally relates to a recording device, a controller and a control method of the recording device.

2. Description of the Related Art

As one of methods for increasing the security of a recording device such as an HDD, there is a technique that data is recorded after being encrypted with an encryption key. In this technique, to maintain the strength of security, it is advantageous to update the encryption key on the regular basis. When the encryption key is updated, the data recorded in the recording device is decrypted with the old encryption key and then encrypted with a new encryption key and recorded again.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 is a perspective view of a magnetic disk device 10 according to an embodiment;

FIG. 2 is a block diagram showing an example system configuration of the magnetic disk device according to the embodiment;

FIG. 3 is a block diagram showing an example functional configuration of a hard disk controller of the magnetic disk device according to the embodiment;

FIG. 4A is an example data structure of data to be recorded in each sector of the magnetic disk of the magnetic disk device according to the embodiment;

FIG. 4B is an example data structure of data to be recorded in each sector of the magnetic disk of a related-art magnetic disk device;

FIG. 5 shows example operation of updating the encryption key of encrypted data stored in sectors of the magnetic disk of the magnetic disk device according to the embodiment;

FIG. 6 is a flowchart showing an example re-encryption process which is executed by the magnetic disk device according to the embodiment; and

FIG. 7 is a flowchart showing an example process which is executed by the magnetic disk device according to the embodiment when an access request is received from a host device.

### DETAILED DESCRIPTION

According to some embodiments of the present invention, there is provided a recording device. The recording device includes: a recording medium having a plurality of sectors; a first writing module configured to write, on a first sector of the plurality of sectors, a first data encrypted using a first encryption key and first encryption key information indicative of the first encryption key; and a re-encrypting module configured to: read the first data from the recording medium; decrypt the first data using the first encryption key to generate decrypted first data; encrypt the decrypted first data using a second encryption key to generate encrypted second data; and write, on the first sector, the encrypted second data and information indicative of the second encryption key.

An embodiment will be hereinafter described with reference to the drawings.

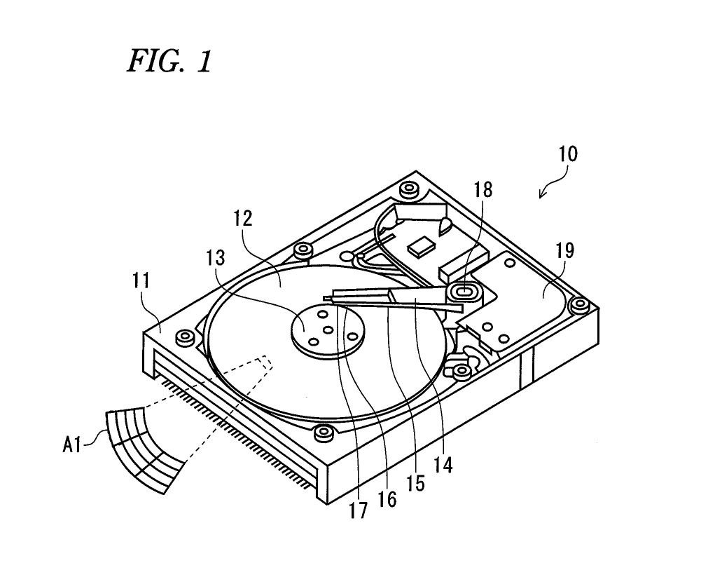

FIG. 1 is a perspective view of a magnetic disk device 10 according to the embodiment. The magnetic disk device 10 is equipped, inside its case 11, with a magnetic disk 12, a spindle motor 13, an actuator arm 14, a suspension 15, a head slider 16, a magnetic head 17, a pivot 18, a voice coil motor (VCM) 19, etc.

The magnetic disk 12, which is a recording medium on which data are to be recorded, is supported rotatably by the spindle motor 13. The magnetic disk 12 is provided with tracks for respective different radius values, and each track has plural readable and writable sectors such as a sector A1.

The actuator arm 14 is attached rotatably to the pivot 18, and the suspension 15 is connected to one end of the actuator arm 14. The head slider 16 is supported elastically by the suspension 15 via a gimbal (not shown), and is mounted with the magnetic head 17. The magnetic head 17 functions as a write head and a read head for writing and reading data to and from the magnetic disk 12.

The voice coil motor 19, which is disposed adjacent to the other end, opposite to the end to which the suspension 15 is connected, of the actuator arm 14, rotates the actuator arm 14 around the pivot 18 and thereby positions the magnetic head 17 at an arbitrary radial position of the magnetic disk 12 in such a manner that the magnetic head 17 floats over the magnetic disk 12.

Supported in the above manner, the magnetic head 17 is moved in the radial direction, whereby an arbitrary sector of an arbitrary track can be scanned for and data can be written to or read from that sector.

It is preferable to increase the security of data by writing the data after encrypting it. In this connection, the magnetic disk device 10 according to the embodiment can record, on the magnetic disk 12, data encrypted with an encryption key and can update the encryption key of encrypted data recorded on the magnetic disk 12 on a regular basis, for example. The magnetic disk device 10 can judge whether the encryption key of data that is read from the magnetic disk 12 has been updated or not and decrypt the data with an encryption key that accords with a judgment result.

In conventional magnetic recording devices, a database is provided which indicates with what encryption keys respective data were encrypted. When data is read from the magnetic disk, an encryption key to be used for decrypting the data is determined by loading the database into a memory and referring to it. However, where the amount of encrypted data is huge, the database may occupy an unduly large storage area of the memory or the processing of referring to the database may unduly increase the processing amount of the magnetic recording device.

In contrast, in the magnetic disk device 10 according to the embodiment, data that has been encrypted with an encryption key and information relating to the encryption key are recorded for every one or more sectors, whereby the processing amount of data encryption can be suppressed.

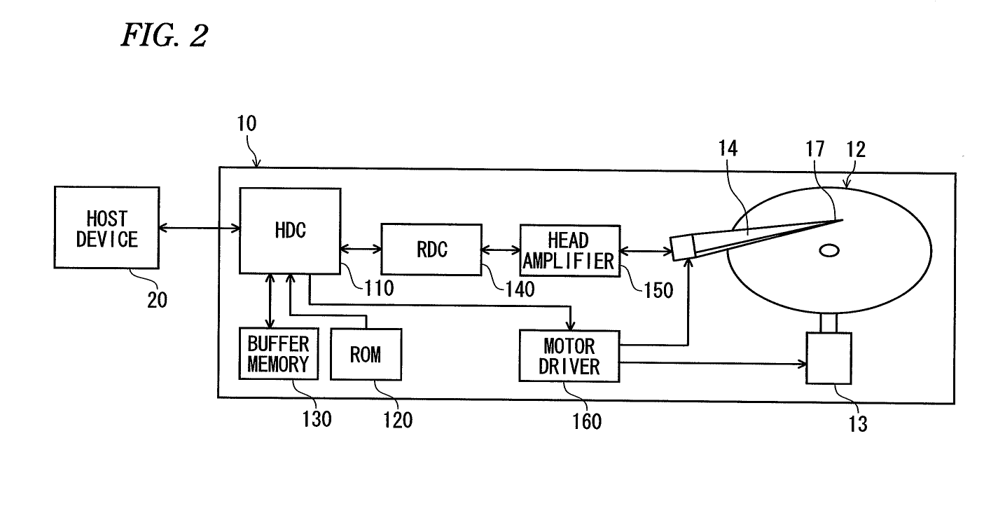

Next, an example system configuration of the magnetic disk device 10 according to the embodiment will be described with reference to FIG. 2. FIG. 2 is a block diagram showing an example system configuration of the magnetic disk device 10 according to the embodiment.

The magnetic disk device 10 is equipped with a hard disk controller (HDC) 110, a buffer memory 130, a read/write channel (RDC) 140, a head amplifier 150, a motor driver 160, etc.

The HDC 110 has a function of reading firmware from a ROM 120 into a memory (not shown) and controlling the entire magnetic disk device 10 according to the firmware. For example, the HDC 110 controls processing of outputting and receiving data to and from a host computer (host device) 20, processing of writing and reading data to and from the magnetic disk 12, and error correction processing on data read from the magnetic disk 12. The host device 20 is an information processing apparatus such as a computer that incorporates the magnetic disk device 10, an information processing apparatus to which the magnetic disk device 10 is connected externally, or a like apparatus.

When receiving, from the host device 20, a read request to read data from the magnetic disk 12, the HDC 110 controls the voice coil motor 19 by outputting an instruction to the motor driver 160 on the basis of address information that is contained in the read request. The address information is information indicating in what sector of the magnetic disk 12 data is recorded. For example, the address information is of an LBA (logical block addressing) scheme in which numbers are assigned to all sectors of a magnetic disk.

The HDC 110 adjusts the position of the magnetic head 17 with respect to the magnetic disk 12 by controlling the voice coil motor 19, and reads data from a sector specified by the read request supplied from the host device 20. The HDC 110 outputs the read-out data to the host device 20 after buffering it in the buffer memory 130.

When receiving, from the host device 20, a write request to write data to the magnetic disk 12, the HDC 110 receives, from the host device 20, data to be written to the magnetic disk 12 and buffers it in the buffer memory 130. Then, the HDC 110 supplies the buffered data to the RDC 140. Furthermore, the HDC 110 controls the position of the magnetic head 17 by driving the voice coil motor 19 by outputting an instruction to the motor driver 160. The data that is input to the RDC 140 is supplied to the magnetic head 17 via the head amplifier 150 and written to the magnetic disk 12.

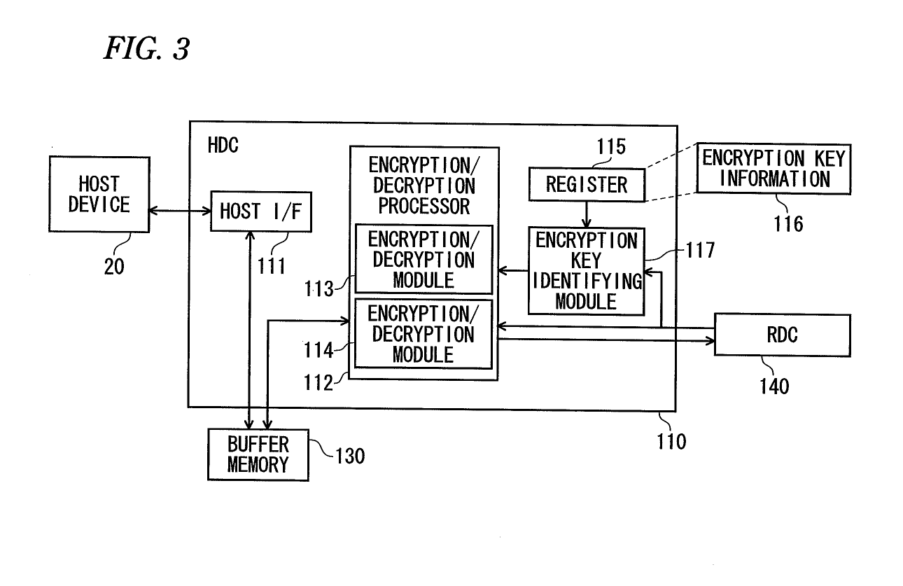

The HDC 110 has a function of encrypting and decrypting data, a function of identifying an encryption key of encrypted data, and other functions, which will be described later in detail with reference to FIGS. 3-7.

The buffer memory 130 has a function of buffering, under the control of the HDC 110, data that is exchanged between the host device 20 and the magnetic disk device 10.

The RDC 140 has a function of code-modulating data that is input from the HDC 110 and code-demodulating data to be output to the HDC 110. When receiving, from the host device 20, write data to be written to the magnetic disk 12, the RDC 140 code-modulates the received data and supplies resulting data to the head amplifier 150. When receiving, from the head amplifier 150, a signal that is read from the magnetic disk 12 via the head amplifier 150, the RDC 140 code-demodulates the received signal and outputs digital data to the HDC 110.

The head amplifier 150 amplifies a signal that is read from the magnetic disk 12 by the magnetic head 17 and outputs a resulting signal to the RDC 140. Furthermore, the head amplifier 150 amplifies a signal of write data to be written to the magnetic disk 12 and outputs resulting data to the magnetic head 17 to cause the magnetic head 17 to write the data to the magnetic disk 12.

The motor driver 160 drives the spindle motor 13 and the voice coil motor 19 (not shown in FIG. 2) according to an instruction from the HDC 110. More specifically, the motor driver 160 rotates the magnetic disk 12 at a prescribed rotation speed by controlling the spindle motor 13 and moves the magnetic head 17 (provided at the tip of the actuator arm 14) in the radial direction of the magnetic disk 12 by controlling the voice coil motor 19.

Next, an example functional configuration of the HDC 110 will be described with reference to a block diagram of FIG. 3. As shown in FIG. 3, the HDC 110 is provided with a host interface (I/F) 111, an encryption/decryption processor 112, a register 115, an encryption key identifying module 117, etc.

The host I/F 111 has a function of outputting and inputting data to and from the host device 20 via an I/F bus. When receiving data from the host device 20, the host I/F 111 supplies the received data to the buffer memory 130. When receiving data from the buffer memory 130, the host I/F 111 sends the received data to the host device 20. The host I/F 111 may output data received from the host device 20 to the encryption/decryption processor 112 without buffering it in the buffer memory 130, and may receive data from the encryption/decryption processor 112 without buffering it in the buffer memory 130.

The encryption/decryption processor 112 is provided with two encryption/decryption modules 113 and 114. The encryption/decryption processor 112 encrypts data to be output to the RDC 140 and decrypts encrypted data that is input from the RDC 140. Different encryption keys are set in the encryption/decryption modules 113 and 114, and each of the encryption/decryption modules 113 and 114 can perform encryption/decryption processing using the encryption key that is set therein.

The encryption/decryption processor 112 changes the encryption key to be used for encryption by switching the module for encrypting data. The encryption key may be changed every prescribed time or every time an encryption key change request is received from the user via the host device 20. The encryption keys that are set in the respective encryption/decryption modules 113 and 114 can be updated alternately and, for example, are generated/updated regularly by firmware that is read from the ROM 120 by the HDC 110.

In changing the encryption key to be used for encrypting data to be recorded on the magnetic disk 12, that is, in switching the module for encrypting data from one of the encryption/decryption modules 113 and 114 to the other, the encryption/decryption processor 112 performs re-encryption processing of encrypting the data recorded on the magnetic disk 12 using the module in which a new encryption key is set and recording resulting data on the magnetic disk 12 again. The encryption key that has been used before the encryption key change will be referred to below as an “old encryption key.”

In the re-encryption processing, the encryption/decryption processor 112 reads the encrypted data from the magnetic disk 12 and decrypts the read-out encrypted data using the one of the encryption/decryption modules 113 and 114 in which the old encryption key is set. Then, the encryption/decryption processor 112 encrypts decrypted data using the other of the encryption/decryption modules 113 and 114 in which a new encryption key is set. The encryption/decryption processor 112 outputs data that have been encrypted with the new encryption key and encryption key identification information indicating the new encryption key to the magnetic disk 12 via the RDC 140.

If the HDC 110 receives an access request from the host device 20 during re-encryption processing, the encryption/decryption processor 112 decrypts or encrypts data by controlling the encryption/decryption modules 113 and 114 according to the access request.

How the encryption/decryption modules 113 and 114 are controlled in such a situation will be described separately for read processing of reading data from the magnetic disk 12 when the HDC 110 receives a data read request from the host device 20 and write processing of writing data to the magnetic disk 12 when the HDC 110 receives a data write request from the host device 20.

In read processing, the encryption/decryption processor 112 decrypts encrypted data received from the RDC 140 according to an encryption key notice that is input from the encryption key identifying module 117. More specifically, the encryption/decryption processor 112 decrypts encrypted data received from the RDC 140 using, according to an encryption key notice, the one of the encryption/decryption modules 113 and 114 in which the encryption key of the encrypted data is set. The encryption key notice is a notice to be used for identifying the encryption key of encrypted data that is input to the encryption/decryption processor 112 from the RDC 140.

Decrypted data is output to the buffer memory 130 and then sent to the host device 20 via the host I/F 111.

On the other hand, in write processing, when a write request and data are received from the host device 20 via the host I/F 111 and the buffer memory 130, the encryption/decryption processor 112 encrypts the data using the one of the encryption/decryption modules 113 and 114 in which a new encryption key is set. Then, the encryption/decryption processor 112 outputs resulting encrypted data and encryption key identification information indicating the new encryption key to the RDC 140.

The register 115 stores pieces of encryption key information 116 indicating a new encryption key and an old encryption key that are set in the encryption/decryption modules 113 and 114. For example, the register 115 stores, as pieces of encryption key information 116, a number indicating a new encryption key and a number indicating an old encryption key. That is, a new encryption key and an old encryption key may be discriminated from each other by correlating “0” and “1,” for example, with the new encryption key and the old encryption key, respectively. The register 115 may be stored, as pieces of encryption key information 116, with any pieces of information that are in such a form as to enable discrimination between a new encryption key and an old encryption key.

When the HDC 110 reads recorded data from the magnetic disk 12, the encryption key identifying module 117 extracts encryption key identification information indicating the encryption key that was used for encrypting the subject data. For example, each piece of encryption key identification information is stored for every sector or every prescribed number of sectors of the magnetic disk 12.

The encryption key identifying module 117 judges with what encryption key the read-out data was encrypted on the basis of the pieces of encryption key information 116 stored in the register 115 and the sector-by-sector encryption key identification information extracted from the read-out data, and outputs an encryption key notice relating to the encryption key of the read-out data to the encryption/decryption processor 112.

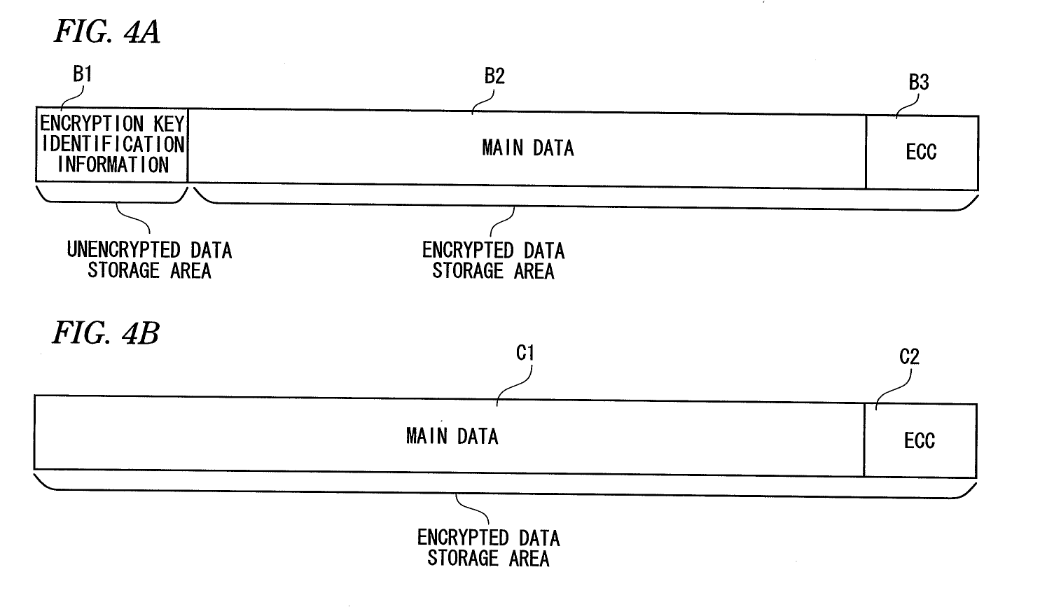

Next, an example data structure of data to be written to the magnetic disk 12 with reference to FIGS. 4A and 4B. FIG. 4A shows an example data structure of data to be written to each sector of the magnetic disk 12 of the magnetic disk device 10 according to the embodiment.

For example, as shown in FIG. 4A, encryption key identification information B1, main data B2, and an ECC (error correcting code) B3 are stored in each sector of the magnetic disk 12.

The encryption key identification information B1 is information indicating with what encryption key the main data B2 and the ECC B3 were encrypted. The encryption key identification information B1 may be any information of such a form as to enable identification of the encryption key of the main data B2 and the ECC B3 when the magnetic disk device 10 compares the encryption key identification information B1 with the pieces of encryption key information 116 stored in the register 115. That is, the encryption key identification information B1 may be “1” or “0,” for example, and thereby indicates with what encryption key the main data B2 and the ECC B3 were encrypted.

The main data B2 is data such as user data, and the ECC B3 is data to be used for error correction of the main data B2. The encryption key identification information B1 is data that was not encrypted by the encryption/decryption processor 112, and the main data B2 and the ECC B3 are encrypted data.

That is, each sector of the magnetic disk 12 has an unencrypted data storage area for storing encryption key identification information B1 and an encrypted data storage area for storing main data B2 and an ECC B3. The ECC B3 need not always be encrypted.

FIG. 4B shows an example data structure of data to be written to each sector of the magnetic disk of conventional magnetic disk devices. In conventional magnetic disk devices, each sector is not provided with a storage area for storing encryption key identification information B1 and each sector is not provided with both of an unencrypted data storage area and an encrypted data storage area.

Although in the example of FIG. 4A encryption key identification information B1 is stored in each sector of the magnetic disk 12 of the magnetic disk device 10 according to the embodiment, encryption key identification information B1 may be stored in every plural number of sectors.

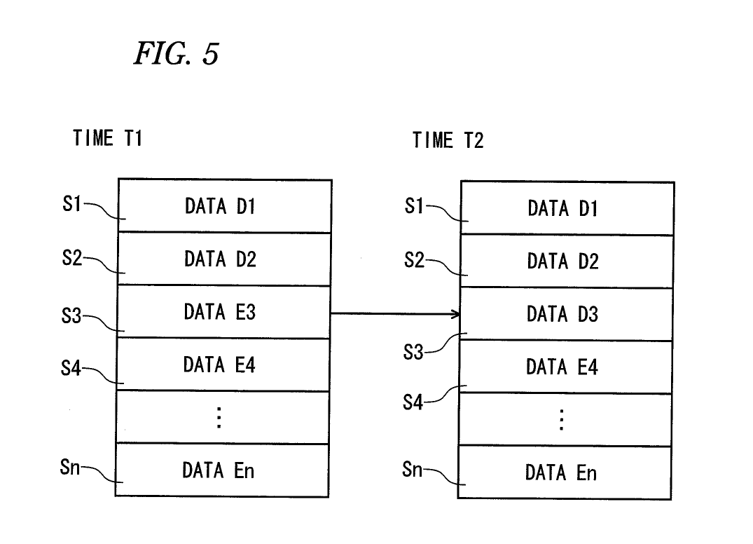

Next, an example operation of re-encrypting encrypted data that is recorded on the magnetic disk 12 of the magnetic disk device 10 with reference to FIG. 5. FIG. 5 shows example encrypted data that are stored in sectors S1-Sn at time T1 and time T2 in a re-encrypting operation. Data D1-D3 are data that have been encrypted with a new data and data E3-En are data that were encrypted with an old encryption key.

The data E3 that is recorded in the sector S3 at time T1 as data that was encrypted with the old encryption key is decrypted with the old encryption key by the encryption/decryption processor 112 and then encrypted with the new encryption key. The data D3 that has been encrypted with the new encryption key is written to the same sector S3 as the original data E3 was recorded in.

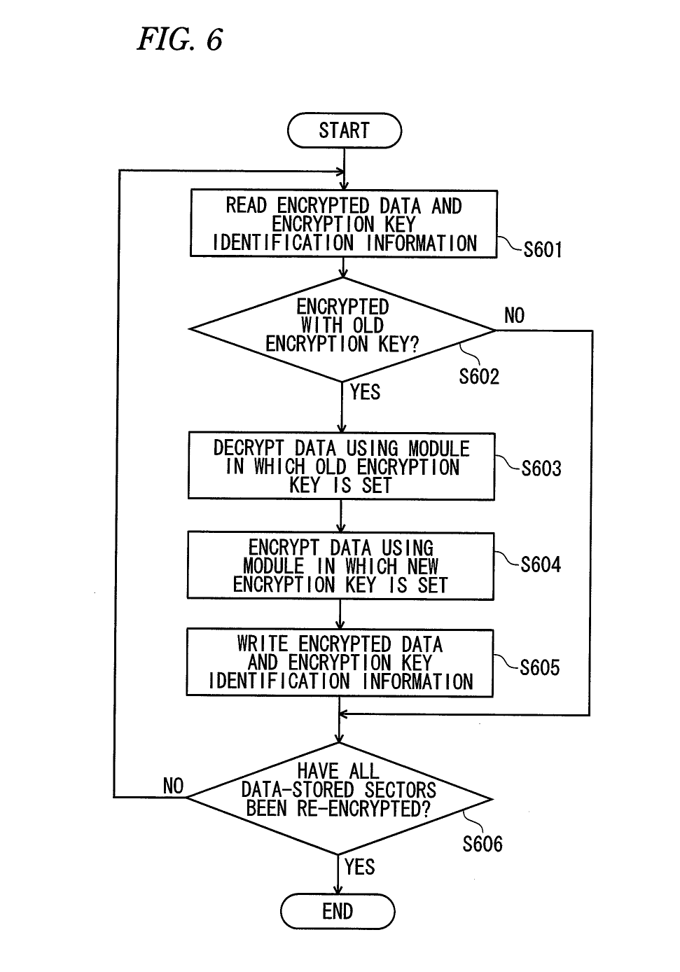

Next, an example re-encryption process which is executed by the magnetic disk device 10 will be described with reference to FIG. 6. For example, this re-encryption process is executed every prescribed time.

First, at step S601, the magnetic head 17 reads recorded data of one sector, for example, from the magnetic disk 12. The read-out data of one sector is input to the HDC 110 via the head amplifier 150 and the RDC 140.

At step S602, the encryption key identifying module 117 extracts the encryption key identification information B1 from the 1-sector data that has been input to the HDC 110, and identifies the encryption key that was used for encrypting the data that has been input to the HDC 110 on the basis of the encryption key identification information B1 and the pieces of encryption key information 116 stored in the register 115. After identifying the encryption key, the encryption key identifying module 117 outputs an encryption key notice indicating the encryption key to the encryption/decryption processor 112.

If the data was encrypted with an old encryption key (S602: yes), at step S603 the encryption/decryption processor 112 decrypts the 1-sector data that has been input to the HDC 110 using one of the modules 113 and 114 in which an unupdated encryption key, that is, the old encryption key, is set.

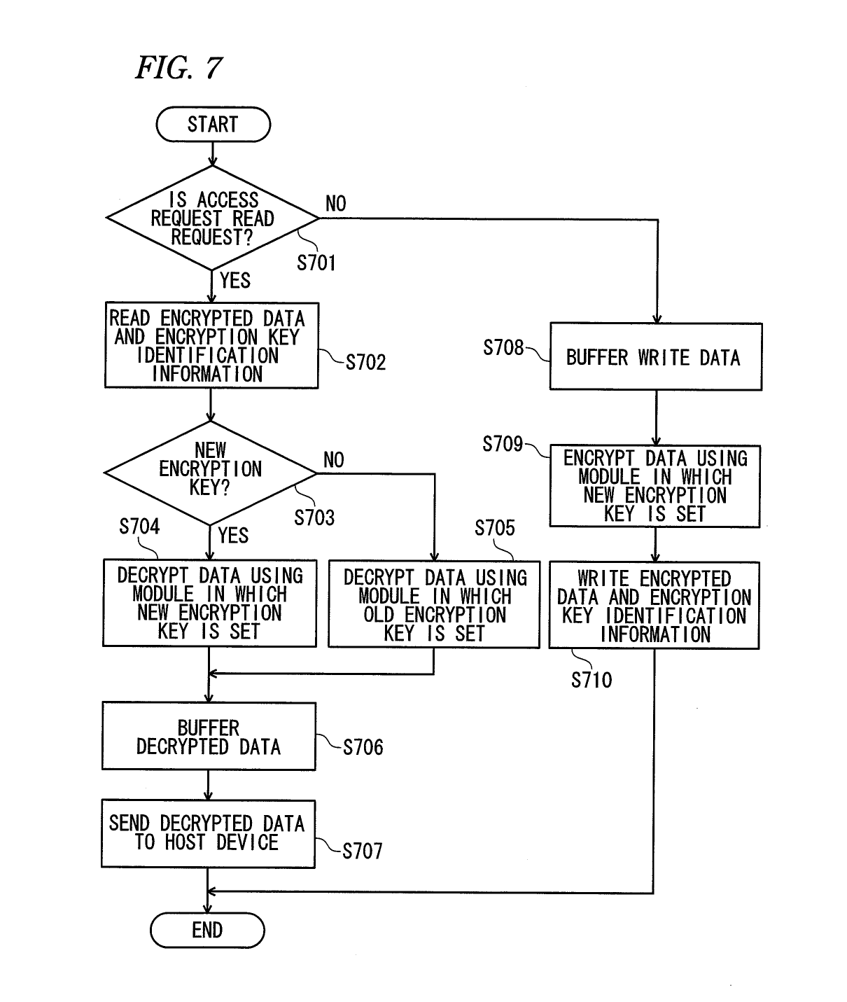

On the other hand, if the data was encrypted with a new encryption key (S602: no), the process moves to step S606. An event that data was encrypted with a new encryption key occurs when, for example, a sector that has not been re-encrypted by re-encryption processing yet has been encrypted with the new encryption key in a data writing process (see FIG. 7).

At step S604, the encryption/decryption processor 112 encrypts decrypted data using the module in which an updated encryption key, that is, the new encryption key, is set. After decrypting the data at step S603, the encryption/decryption processor 112 may judge whether or not the decryption has been performed as the decryption step of a re-encryption process and execute step S604 if the judgment result is affirmative.

At step S605, the encryption/decryption processor 112 adds, to the encrypted data, encryption key identification information indicating the encryption key that has been used for encrypting the data and outputs resulting data to the RDC 140. The magnetic head 17 writes the encrypted data and the encryption key identification information in the same sector as the original encrypted data was read from.

After the re-encryption steps for the 1-sector data have been executed at steps S601-S605, at step S606 the HDC 110 judges whether or not all data-stored sectors among all the sectors of the magnetic disk 12 have been subjected to the re-encryption steps S601-S605. If not all the data-stored sectors have been subjected to the re-encryption steps S601-S605 (S606: no), the encryption/decryption processor 112 executes step S601 again. If all the data-stored sectors have been subjected to the re-encryption steps S601-S605 (S606: yes), the re-encryption process is finished.

In the re-encryption process, after data that is read from the magnetic disk 12 is decrypted and re-encrypted, resulting re-encrypted data may be written to the magnetic disk 12 after being buffered in the buffer memory 130. Alternatively, the re-encrypted data may be written to the magnetic disk 12 without being buffered in the buffer memory 130. This makes it possible to reduce the processing load of the magnetic disk device 10.

Next, an example process which is executed by the magnetic disk device 10 according too the embodiment when an access request is received from the host device 20 will be described with reference to FIG. 7. The magnetic disk device 10 starts this process when, for example, receiving an access request from the host device 20 during execution of the re-encryption process of FIG. 6.

First, at step S701, the magnetic disk device 10 judges whether an access request from the host device 20 is a read request to read data from the magnetic disk 12 or a write request to write data to the magnetic disk 12.

If the access request is a read request (S701: yes), the magnetic head 17 reads data such as encryption key identification information B1, main data B2, and an ECC B3 from a sector specified by the read request. At step S702, the read-out data is input to the HDC 110 via the head amplifier 150 and the RDC 140. At step S703, the encryption key identifying module 117 identifies the encryption key of the data on the basis of the encryption key identification information B1 contained in the received data and the pieces of encryption key information stored in the register 115.

If the encryption key is a new encryption key (S703: yes), at step S704 the encryption/decryption processor 112 decrypts the data using one of encryption/decryption modules 113 and 114 in which the new encryption key is set. On the other hand, if the encryption key is an old encryption key (S703: no), at step S705 the encryption/decryption processor 112 decrypts the data using the other of encryption/decryption modules 113 and 114 in which the old encryption key is set.

The HDC 110 buffers data that has been decrypted with the new encryption key or the old encryption key in the buffer memory 130 at step S706, and sends the decrypted data to the host device 20 via the host I/F 111 at step S707. After decrypting the data at step S704 or S705, the encryption/decryption processor 112 may judge whether or not the decryption has been performed as a decryption step of a decryption process being executed in response to a write request and execute steps S706 and S707 if the judgment result is affirmative.

On the other hand, if receiving a write request (S701: no), at S708 the HDC 110 buffers, in the buffer memory 130, data to be written to the magnetic disk 12 that is input from the host device 20 via the host I/F 111.

At step S709, the encryption/decryption processor 112 encrypts the data buffered in the buffer memory 130 using the one of the encryption/decryption modules 113 and 114 in which the new encryption key is set. At step S709, for example, the encryption/decryption processor 112 can read, from the buffer memory 130, buffered data having the same size as a storage area in which main data B2 (see FIG. 4A) is to be stored and encrypt the read-out data.

At step S710, the encryption/decryption processor 112 outputs, to the RDC 140, data containing encrypted data and encryption key identification information indicating the encryption key that has been used for the encryption. The magnetic head 17 writes the data to the magnetic disk 12.

When receiving a read request from the host device 20, the magnetic disk device 10 may buffer data that is read from the magnetic disk 12 in the buffer memory 130 before decryption by the encryption/decryption processor 112. When receiving a write request from the host device 20, the magnetic disk device 10 may write data received from the host device 20 to the magnetic disk 12 after encrypting the data with the encryption/decryption processor 112 and buffering resulting data in the buffer memory 130.

The process of FIG. 7 may also be executed in, for example, a data refreshing process of rewriting data of magnetism-weakened sectors of the magnetic disk 12 of the magnetic disk device 10 to the same sectors.

In the magnetic disk device 10 according to the embodiment, encryption key identification information indicating with what encryption key data recorded in each sector of the magnetic disk 12 was encrypted can be stored in the same sector. This makes it possible to prevent an event that an encryption key database occupies an unduly large storage area of the memory of the magnetic disk device 10.

In the magnetic disk device 10 according to the embodiment, since encrypted data and encryption key identification information are read, processing of referring to an encryption key database need not be provided.

Furthermore, in re-encryption processing, the magnetic disk device 10 can write re-encrypted data to the same sector of the magnetic disk 12 as original encrypted data has been read from. Therefore, the frequency of execution of processing of updating address information indicating a position of data on the magnetic disk 12 can be lowered and the processing amount of re-encryption processing can thus be reduced.

The invention is not limited to the above embodiment itself and, in the practice stage, may be embodied in such a manner that constituent elements are modified without departing from the spirit and scope of the invention. And various inventions can be conceived by properly combining plural constituent elements disclosed in the embodiment. For example, several ones of the constituent elements of the embodiment may be omitted.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. A recording device comprising:
a recording medium having a plurality of sectors;
a first writing module configured to write, on a first sector of the plurality of sectors, a first data encrypted using a first encryption key and first encryption key information indicative of the first encryption key; and
a re-encrypting module configured to:
read the first data from the recording medium;
decrypt the first data using the first encryption key to generate decrypted first data;
encrypt the decrypted first data using a second encryption key to generate encrypted second data; and
write, on the first sector, the encrypted second data and second encryption key information indicative of the second encryption key.

2. The device of claim 1, further comprising:
a receiving module configured to receive from a host device a read request to read data recorded in the recording medium;
a reading module configured to read a third data from a sector specified by the read request, the third data being encrypted using one of the first and second encryption keys and a corresponding one of the first and second encryption key information;
a decrypting module configured to decrypt the third data using the corresponding encryption key information to generate decrypted fourth data; and
an output module configured to output the decrypted fourth data to the host device.

3. The device of claim 1, further comprising:
a receiving module configured to receive data from a host device;
an encrypting module configured to encrypt the received data using the second encryption key; and
a second writing module configured to write, on at least one sector of the plurality of sectors, the received data encrypted using the second encryption key and the second encryption key information.

4. The device of claim 1, wherein the each of the plurality of sectors of the recording medium comprises an unencrypted data storage area and an encrypted data storage area, and wherein encryption key information is recorded in the unencrypted data storage area.

5. The device of claim 1, wherein the plurality of sectors comprise N sectors and the first encryption key is recorded on a prescribed number E of the plurality of sectors, and wherein E<N.

6. A controller comprising:
a first controller configured to write, on a first sector of a recording medium, a first data encrypted using a first encryption key and first encryption key information indicative of the first encryption key; and
a second controller configured to:
read the first data from the recording medium;
decrypt the first data using the first encryption key to generate decrypted first data;
encrypt the decrypted first data using a second encryption key to generate encrypted second data; and
write, on the first sector, the encrypted second data and second encryption key information indicative of the second encryption key.

7. The controller of claim 6, further comprising:
a receiving module configured to receive from a host device a read request to read data recorded in the recording medium;
a reading module configured to read a third data, from a sector specified by the read request, the third data being encrypted using one of the first and second encryption keys and a corresponding one of the first and second encryption key information;
a decrypting module configured to decrypt the encrypted third data using the corresponding encryption key information to generate decrypted fourth data; and
an output module configured to output the decrypted fourth data to the host device.

8. The controller of claim 6, further comprising:
a receiving module configured to receive data from a host device;
an encrypting module configured to encrypt the received data using the second encryption key; and
a second writing module configured to write, on at least one sector of the plurality of sectors, the received data encrypted using the second encryption key and the second encryption key information.

9. The controller of claim 6, wherein the each of the plurality of sectors of the recording medium comprises an unencrypted data storage area and an encrypted data storage area, and wherein encryption key information is recorded in the unencrypted data storage area.

10. The controller of claim 6, wherein the plurality of sectors comprise N sectors and the first encryption key is recorded on a prescribed number E of the plurality of sectors, and wherein E<N.

11. A method of controlling a recording device, the recording device comprising a recording medium having a first sector, the method comprising:
writing, on the first sector, a first data encrypted using a first encryption key and first encryption key information indicative of the first encryption key;
reading the first data from the recording medium;
decrypting the first data using the first encryption key to generate decrypted first data;
encrypting the decrypted first data using a second encryption key to generate encrypted second data; and
writing, on the first sector, the encrypted second data and second encryption key information indicative of the second encryption key.

12. The method of claim 11, further comprising:
receiving from a host device an access request;
determining if the access request is a read request;
reading encrypted data and encryption key information from the recording medium when the access request is a read request;
selecting one of the first encryption key or the second encryption key based on the encryption key information;
decrypting the encrypted data based on the selected encryption key; and
outputting the decrypted data to the host device.

13. The method of claim 11, further comprising:
receiving from a host device an access request;
determining if the access request is a write request with write data;
selecting the second encryption key;
encrypting received write data using the second encryption key; and
writing the received write data encrypted using the second encryption key and the second encryption key information to the recording medium.

14. The method of claim 11, wherein the recording medium comprises a plurality of sectors having an unencrypted data storage area and an encrypted data storage area, and wherein encryption key information is recorded in the unencrypted data storage area.

15. The controller of claim 11, wherein the recording medium comprises a plurality of sectors N, wherein the first encryption key is recorded on a prescribed number E of the plurality of sectors, and wherein E<N.
